(19) United States
(12) Patent Application Publication
(10) Pub. No.: US 2010/0061256 A1
(43) Pub. Date: Mar. 11, 2010

(54) Methods of Determining Whether a Frequency Channel is Available for Data Transmission for a Communication Device

(75) Inventors: Chee Wei Ang, Singapore (SG); Peng Yong Kong, Singapore (SG); Anh Tuan Hoang, Singapore (SG); Ying-Chang Liang, Singapore (SG); Haiguang Wang, Singapore (SG)

Correspondence Address: CROCKETT & CROCKETT, P.C., 26020 ACERO, SUITE 200, MISSION VIEJO, CA, 92691, US

(73) Assignee: AGENCY FOR SCIENCE, TECHNOLOGY AND RESEARCH, Singapore (SG)

(21) Appl. No.: 12/302,137

(22) PCT Filed: May 25, 2007
(86) PCT No.: PCT/SG07/00150

§ 371 Date: Sep. 11, 2009

Related U.S. Application Data
(60) Provisional application No. 60/809,040, filed on May 25, 2006.

(51) Int. Cl. H04L 12/26; H04J 1/00

(52) U.S. Cl. 370/252; 370/343

(57) ABSTRACT

A method of determining whether a frequency channel is available for data transmission for a communication device is provided. The method provided comprises dynamically selecting a time interval for determining whether the frequency channel is available for data transmission for the communication device. The method provided further comprises determining whether the frequency channel is available for data transmission for the communication device, during the time interval selected.

The present application claims the benefit of U.S. provisional application No. 60/809,040 (filed on 25 May, 2006), the entire contents of which are incorporated herein by reference for all purposes.

### FIELD OF THE INVENTION

The present invention refers to methods of determining whether a frequency channel is available for data transmission for a communication device, as well as to respective devices.

### BACKGROUND OF THE INVENTION

A cognitive radio system operates in frequency channels that are licensed for a specific communication service. In this context, this specific communication service is typically referred to as the incumbent service, and existing users of the incumbent service are known as incumbent users (or primary users). For example, the cognitive radio system may be the IEEE 802.22 Wireless Regional Area Network [1].

Additionally, a cognitive radio system which is designed for providing, access to wired networks, such as the Internet, may adopt a point-to-multipoint (PMP) topology. In the point-to-multipoint topology, the cognitive radio system consists of a basestation (BS) and a few customer premise equipment (CPE), for example. As such, the few customer premise equipment are served by the (single) basestation.

The basestation also typically comprises a gateway, which provides a connection from the customer premise equipment served by it to a wired network infrastructure. Meanwhile, the customer premise equipment acts as a network access point within an office or a home, for example.

In general, the cognitive radio system is able to co-exist with the incumbent users in the allocated frequency channels, by ‘opportunistically’ using the frequency channels when they are currently not used by the incumbent users, e.g., at certain locations or during specific times.

In order to be able to determine whether a frequency channel is being used by incumbent users, the cognitive radio system regularly performs a process called sensing. During the sensing process, the cognitive radio system periodically detects the presence of signal transmissions by nearby incumbent users, across a range of frequency channels. Accordingly, the status of whether a frequency channel is being used by incumbent users or not, is compiled for a range of frequency channels. In this regard, once the cognitive radio system finds an unused frequency channel, the cognitive radio system may then proceed to operate in this unused frequency channel.

The sensing process does not end here. Even while operating in the unused frequency channel found, the cognitive radio system continues to periodically sense for the resumption of any signal transmission by the incumbent user, across the same range of frequency channels, including the frequency channel in which it is operating.

Should the cognitive radio system detect that there is a signal transmission by incumbent users in the frequency channel which it is operating in, it ceases its signal transmission in this frequency channel. If there is another unused frequency channel available, the cognitive radio system may continue its operation in this unused frequency channel. Otherwise, the cognitive radio system ceases its operation.

In this context, the sensing for the presence of signal transmissions by incumbent users in the current operating frequency channel of the cognitive radio system is typically referred to as “in-band sensing”. On the other hand, the sensing for the presence of signal transmissions by incumbent users in all frequency channels other than its current operating frequency channel is typically referred to as “out-of-band sensing”.

For the case of in-band sensing, common quiet periods are scheduled in order to avoid the situation where the basestation and the customer premise equipment in the same cognitive radio system end up sensing one another. On the other hand, since the basestation and the customer premise equipment are not transmitting in the out-of-band frequency channels, there is no need for out-of-band sensing to be carried out by the basestation and the customer premise equipment in a synchronized manner. Accordingly, there is no need to schedule common quiet periods for out-of-band sensing.

Further, for the case of in-band sensing, a conventional method for allocating common quiet periods is to schedule common quiet periods at fixed regular intervals, for example, during the last frame time interval of a superframe. In this example, there will be one common quiet period for in-band sensing after every superframe interval.

In this regard, a frame structure refers to the form which defines how a time interval is partitioned into a number of sub-intervals. In this context, a time interval of a predefined period is typically called a frame, and a sub-interval resulting from a predefined partitioning process is typically called a subframe. In this conjunction, an aggregate of a number of adjacent frames is typically called a superframe, or a frame group.

An alternative method for allocating common quiet periods for in-band sensing is the methods as defined in the respective independent claims of the present application.

### SUMMARY OF THE INVENTION

In a first aspect of the invention, a method of determining whether a frequency channel is available for data transmission for a communication device is provided. The method provided comprises dynamically selecting a time interval for determining whether the frequency channel is available for data transmission for the communication device. The method provided further comprises determining whether the frequency channel is available for data transmission for the communication device, during the time interval selected.

In this regard, the time interval may be, but is not limited to, a current time interval, for example.

Additionally, the frequency channel may be, but is not limited to, the frequency channel the communication device is currently operating in (or in other words, the in-band frequency channel), for example. Accordingly, in this example, the step of determining whether the frequency channel is available for data transmission for the communication device, may refer to the step of performing of in-band sensing, for example.

Illustratively, in the step of determining whether or not the current time interval is suitable for performing in-band sensing, the current time interval is selected dynamically. This dynamically selected time interval is then used to perform the in-band sensing process in.

In this regard, it is noted that there are alternative embodiments of the invention here. In one embodiment, all communication devices in the system perform the steps of determining and then dynamically selecting a suitable time interval for performing in-band sensing, based on a set of criteria known to all communication devices. Accordingly, all communication devices will arrive at the same decision on a suitable time interval for performing in-band sensing. Therefore, in this embodiment, it is not necessary for any signaling to be carried out in order to inform all communication devices regarding the suitable time interval to be used for performing in-band sensing.

An alternative embodiment of the invention, wherein signaling is used, is given as follows.

In a second aspect of the invention, a method of determining whether a frequency channel is available for data transmission, for a first communication device and a second communication device, is provided. The method provided comprises dynamically selecting a time interval for determining whether the frequency channel is available for data transmission, wherein the selection of the time interval is performed by the first communication device, and transmitting information regarding the time interval selected from the first communication device to the second communication device. The method provided further comprises determining whether the frequency channel is available for data transmission, during the time interval selected, wherein the determining whether the frequency channel is available for data transmission, is performed by the first communication device and the second communication device.

In this embodiment, the first communication device communication device performs the steps of determining and then selecting dynamically a suitable time interval for performing in-band sensing.

Once the suitable time interval is selected, the first communication device transmits this information (regarding the selected suitable time interval) to the second communication device, via suitable signaling processes, for example. Alternatively, the first communication device may transmit this information (regarding the selected suitable time interval) to the second communication device, by appropriately scheduling sensing intervals in the data transmission schedule and then broadcasting the said schedule, for example.

Following which, the first communication device and the second communication device perform in-band sensing during the selected time interval.

For example, in this embodiment, the first communication device may be a transmitting and/or receiving station, which is usually strategically located. In one embodiment, the first communication device is a base station.

In a third aspect of the invention, a frequency channel determination device for determining whether a frequency channel is available for data transmission for a communication device is provided. The device provided comprises a selection unit, dynamically selecting a time interval for determining whether the frequency channel is available for data transmission for the communication device. The device provided further comprises a determination unit, determining whether the frequency channel is available for data transmission for the communication device, during the time interval selected.

In a fourth aspect of the invention, a communication device, comprising a frequency channel determination device for determining whether a frequency channel is available for data transmission for the communication device, the frequency channel determination device comprising a selection unit, dynamically selecting a time interval for determining whether the frequency channel is available for data transmission for the communication device, and a determination unit, determining whether the frequency channel is available for data transmission for the communication device, during the time interval selected.

Embodiments of the invention emerge from the dependent claims.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a communication system according to an embodiment of the invention.

FIG. 2 shows a flow chart describing a first method of determining whether the current frame time interval is selected for performing in-band sensing, according to one embodiment of the invention.

FIG. 3 shows a flow chart describing a second method of determining whether the current frame time interval is selected for performing in-band sensing, according to one embodiment of the invention.

FIG. 4 shows a flow chart describing a third method of determining whether the current frame time interval is selected for performing in-band sensing, according to one embodiment of the invention.

FIG. 5 shows a timing diagram which indicates where common quiet periods for in-band sensing may be dynamically allocated, according to one embodiment of the invention.

FIG. 6 shows the performance results of one embodiment of the invention, with regard to the detection delay parameter.

FIG. 7 shows a set of performance results of one embodiment of the invention, with regard to the throughput parameter.

FIG. 8 shows a set of performance results of one embodiment of the invention, with regard to the average data packet delay parameter.

FIG. 9 shows another set of performance results of one embodiment of the invention, with regard to the detection delay parameter.

FIG. 10 shows another set of performance results of one embodiment of the invention, with regard to the throughput parameter.

FIG. 11 shows another set of performance results of one embodiment of the invention, with regard to the average data packet delay parameter.

### DETAILED DESCRIPTION OF THE INVENTION

According to one embodiment of the invention, the time interval is selected in accordance with a predetermined criterion.

According to one embodiment of the invention, the predetermined criterion is that no data transmission is scheduled for the time interval.

In this embodiment, the time interval is selected for determining whether the frequency channel is available for data transmission, if no data transmission is scheduled for the time interval.

According to another embodiment of the invention, the method provided further comprises determining whether the frequency channel is available for data transmission for the communication device, during the time interval, if it is determined that the time interval is not used for determining whether another frequency channel is available for data transmission for the communication device.

In this embodiment, the time interval is used for determining whether the frequency channel is available for data transmission, if no data transmission is scheduled for the time interval, and if it is determined that the time interval is not used for determining whether another frequency channel is available for data transmission for the communication device.

In this regard, the other frequency channel may be, but is not limited to, an out-of-band frequency channel, for example.

According to one embodiment of the invention, the predetermined criterion is that the amount of backlog data, including data scheduled to be transmitted during the time interval, is less than a first predetermined value.

In this embodiment, the time interval is selected for determining whether the frequency channel is available for data transmission, if the amount of backlog data, including data scheduled to be transmitted during the time interval, is less than a first predetermined value.

In this regard, for example, it can be seen that if the time interval is selected for determining whether the frequency channel is available for data transmission, the data originally scheduled to be transmitted during the time interval would not be transmitted during the time interval, but during one or more time interval(s) following the time interval. In other words, if a backlog did not exist previously, a backlog is automatically created, which comprises the data originally scheduled to be transmitted during the time interval.

Alternatively, if a backlog already exists, the data originally scheduled to be transmitted during the time interval is added to the backlog.

Accordingly, in this embodiment, if this backlog may be cleared satisfactorily within a number of time intervals following the time interval, then the time interval may be selected for determining whether the frequency channel is available for data transmission. Otherwise, if this backlog may not be cleared satisfactorily within a number of time intervals following the time interval, then the time interval may not be selected for determining whether the frequency channel is available for data transmission.

According to another embodiment of the invention, the first predetermined value is a measure of the remaining data transmission capacity. In one embodiment, the first predetermined value has a value in the range from 0 to 1.

According to one embodiment of the invention, the method provided further comprises determining whether the frequency channel is available for data transmission for the communication device, during the time interval, if it is determined that a predetermined detection time interval will expire during the time interval immediately following the time interval selected.

In this embodiment, the time interval is selected for use in determining whether the frequency channel is available for data transmission, if it is determined that a predetermined detection time interval will expire during the time interval immediately following the first time interval selected.

In one embodiment, the length of the predetermined detection time interval is less than 2 seconds.

According to one embodiment of the invention, the predetermined criterion is that the percentage of reports received by the communication device or another communication device, indicating that the frequency channel is not available for data transmission for the communication device, is greater than a second predetermined value.

In this embodiment, the time interval is selected for determining whether the frequency channel is available for data transmission, if the percentage of reports received by the communication device or another communication device, indicating that the frequency channel is not available for data transmission for the communication device, is greater than a second predetermined value.

Illustratively, if a previous in-band sensing were carried out previously, and a significant number of in-band sensing reports received indicate that an incumbent signal transmission is present, the current time interval would be considered as suitable for use in performing another in-band sensing, in order to verify the results of the previous in-band sensing carried out.

In one embodiment, the second predetermined value has a percentage value in the range from 20% to 80%. In a preferred embodiment, the second predetermined value is selected to be 50%.

According to one embodiment of the invention, the predetermined criterion is that the average data packet transmission delay measurement is less than a predetermined delay threshold.

In this embodiment, the time interval is selected for determining whether the frequency channel is available for data transmission, if the average data packet transmission delay measurement is less than a predetermined delay threshold.

In one embodiment, the predetermined delay threshold is selected to be 50% of the average data packet transmission delay of the corresponding data traffic class for the data packet, when the traffic load is at 90%.

In this regard, each data packet transmitted belongs to a specific data traffic class. Each data traffic class has different quality of service (QoS) requirements, such as average data packet transmission delay, for example. Accordingly, the predetermined delay threshold may be different for different data traffic classes.

According to one embodiment of the invention, the method provided further comprises determining whether the frequency channel is available for data transmission for the communication device, during the time interval, if it is determined that the time difference between the time interval and another time interval during which the determining whether the frequency channel is available for data transmission for the communication device was last performed, is greater than the predetermined detection time interval.

Illustratively, in this embodiment, if the time difference between the current time and the last time an in-band sensing was performed exceeds the predetermined detection time interval, the current time interval would be selected for use in performing in-band sensing.

According to one embodiment of the invention, the determining whether the frequency channel is available for data transmission for the communication device further comprises determining whether a signal transmission in the frequency channel is below a predetermined threshold, in case the signal transmission in the frequency channel is below the predetermined threshold, then classifying the frequency channel as being available for data transmission, in case the signal transmission in the frequency channel is not below the predetermined threshold, then classifying the frequency channel as being non-available for data transmission.

As used herein, the communication device may be, but is not limited to, a wireline communication device, a powerline communication device, a radio communication device, a terminal communication device or a Consumer Premise Equipment device. A radio communication device, for example, may be but is not limited to, a mobile radio communication device, a satellite radio communication device, or a mobile radio base station.

Additionally, the method provided, may be used in any communication system which uses time division duplex (TDD), for example. In TDD, time division is used to enable bi-directional communication on a single communication resource. While TDD is typically used in wireless communications, TDD may also be used in non-wireless communications. Accordingly, in this embodiment, the communication device may also be a wireline communication device or a powerline communication device.

The embodiments which are described in the context of the methods of determining whether a frequency channel is available for data transmission, provided, are analogously valid for the respective devices.

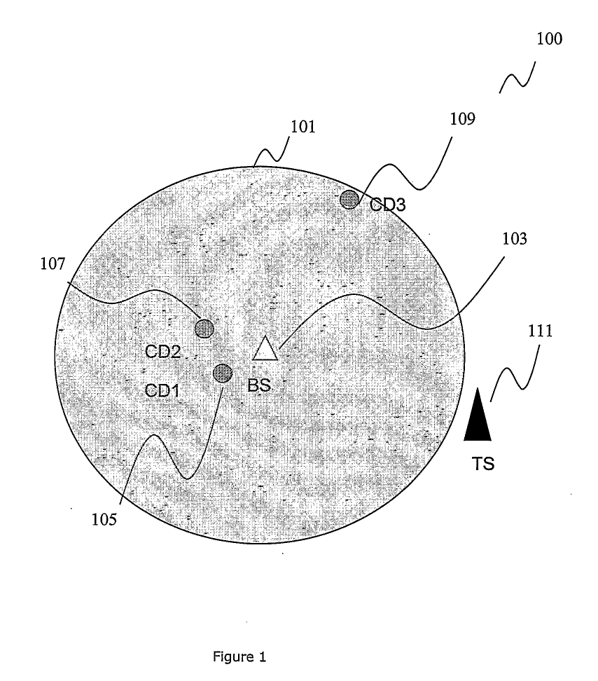

FIG. 1 shows a communication system 100 according to an embodiment of the invention.

The communication system 100 comprises a communication system cell 101, which comprises a base station (BS) 103 and communication devices (CD1 105, CD2 107 and CD3 109).

The data transmission of the communication cell 101 may use frequency channels not used by an incumbent service transmission station (TS) 111, which is located near the communication cell 101. For example, the incumbent service transmission station may be a television broadcast transmission station.

The communication system 100 may be a cognitive radio system, such as the proposed IEEE 802.22 wireless regional area network (WRAN) [1], for example. In this regard, the communication devices (CD1 105, CD2 107 and CD3 109) may be customer premise equipment (CPE).

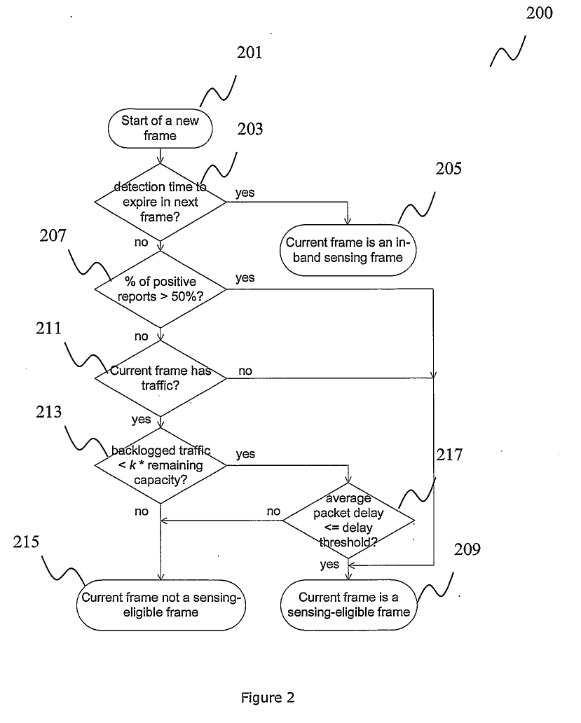

FIG. 2 shows a flow chart 200 describing a first method of determining whether the current frame time interval is selected for performing in-band sensing, according to one embodiment of the invention.

The first method of determining whether the current frame time interval is selected for performing in-band sensing, begins at step 201. In step 203, if it is determined that the detection time interval will expire in the frame time interval following the current frame time interval, the processing moves to step 205, where the current frame time interval will be used for performing in-band sensing.

Alternatively, if it is determined that the detection time interval will not expire in the next frame time interval in step 203, the processing moves to step 207.

In step 207, if it is determined that the percentage of reports received, indicating that the incumbent signal transmission is present, is greater than a second predetermined value, the processing moves to step 209, where it is determined that the current frame time interval is a sensing eligible frame time interval.

As used herein, a sensing eligible frame time interval refers to a time interval which has fulfilled one of the predetermined criteria, and hence, may be used for performing in-band sensing.

In this regard, the predetermined criteria may be, but is not limited to,
a) no data transmission is scheduled for the frame time interval which is being considered,
b) the amount of backlog data, including data scheduled to be transmitted during the frame time interval which is being considered, is less than a first predetermined value,
c) the average data packet transmission delay measurement is less than a predetermined delay threshold, and
d) the percentage of reports received, indicating that the frequency channel is not available for data transmission for the communication device, is greater than a second predetermined value.

In the following, criterion (a) is referred to as the first data traffic-based criterion, criterion (b) is referred to as the second data traffic-based criterion, and criterion (c) is referred to as the third data traffic-based criterion. In this regard, it can be seen that criterion (d) is not a data traffic-based criterion.

Additionally, in this context, the first predetermined value is a measure of the remaining data transmission capacity in the current superframe in this regard, the first predetermined value has a value in the range from 0 to 1, where 0 means that there is no remaining data transmission capacity in the current superframe, and 1 means that there is maximum data transmission capacity remaining in the current superframe. Additionally, the said first predetermined value is also a system parameter.

With regard to the second predetermined value, it was earlier mentioned that in one embodiment, the second predetermined value has a percentage value in the range from 20% to 80%, and that in a preferred embodiment, the second predetermined value is selected to be 50%. It can be seen in this illustration that the second predetermined value is selected to be 50%.

Alternatively, if it is determined that the percentage of reports received, indicating that the incumbent signal transmission is present, is not greater than the second predetermined value (in step 207), the processing moves to step 211.

In step 211, if it is determined that no data transmission is scheduled for the current frame time interval, the processing moves to step 209, where it is determined that the current frame time interval is a sensing eligible frame time interval.

Alternatively, if it is determined that data transmission has been scheduled for the current frame time interval in step 211, the processing next moves to step 213.

In step 213, if it is determined that the amount of backlog data (including the data scheduled to be transmitted during the current frame time interval) is not less than the first predetermined value, the processing moves to step 215, where it is determined that the current frame time interval is not a sensing eligible frame time interval.

As mentioned earlier, the first predetermined value is a measure of the remaining data transmission capacity in the current superframe. In this illustration, the first predetermined value is given by the multiplication of a factor k with the remaining data transmission capacity in the current superframe.

If it is determined that the amount of backlog data (including data scheduled to be transmitted during the current frame time interval) is less than the first predetermined value in step 213, the processing moves to step 217.

In step 217, if it is determined that the average data packet transmission delay measurement is less than the predetermined delay threshold, the processing moves to step 211, where it is determined that the current frame time interval is a sensing eligible frame time interval.

In one embodiment, the predetermined delay threshold is selected to be 50% of the average data packet transmission delay of the corresponding data traffic class for the data packet, when the traffic load is at 90%.

Alternatively, if it is determined that the average data packet transmission delay measurement is not less than the predetermined delay threshold (in step 217), the processing moves to step 215, where it is determined that the current frame time interval is not a sensing eligible frame time interval.

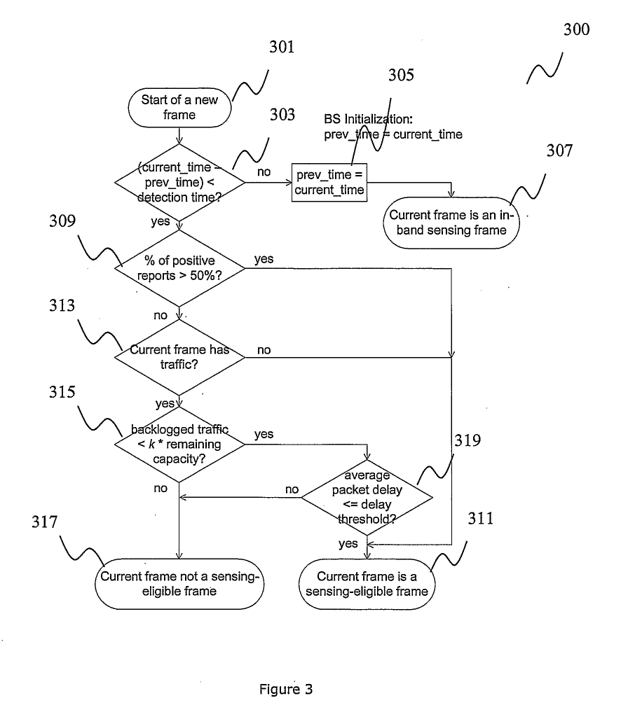

FIG. 3 shows a flow chart 300 describing a second method of determining whether the current frame time interval is selected for performing in-band sensing, according to one embodiment of the invention.

The second method of determining whether the current frame time interval is selected for performing in-band sensing, begins at step 301. In step 303, if it is determined that the time difference between the current time interval and another time interval during which the in-band sensing was last performed, is not less than the predetermined detection time interval, the processing moves to step 305, where the time interval during which the in-band sensing was last performed is set to the current frame time interval. Next, the processing moves to step 307, where the current frame time interval will be used for performing in-band sensing.

Alternatively, if it is determined that the time difference between the current time interval and another time interval during which the in-band sensing was last performed, is less than the predetermined detection time interval, in step 303, the processing moves to step 309.

In step 309, if it is determined that the percentage of reports received, indicating that the incumbent signal transmission is present, is greater than the second predetermined value, the processing moves to step 311, where it is determined that the current frame time interval is a sensing eligible frame time interval.

As a side note, it can be seen in this illustration as well that the second predetermined value is selected to be 50%.

Alternatively, if it is determined that the percentage of reports received, indicating that the incumbent signal transmission is present, is not greater than the second predetermined value (in step 309), the processing moves to step 313.

In step 313, if it is determined that no data transmission is scheduled for the current frame time interval, the processing moves to step 311, where it is determined that the current frame time interval is a sensing eligible frame time interval.

Alternatively, if it is determined that data transmission has been scheduled for the current frame time interval in step 313, the processing next moves to step 315.

In step 315, if it is determined that the amount of backlog data (including the data scheduled to be transmitted during the current frame time interval) is not less than the first predetermined value, the processing moves to step 317, where it is determined that the current frame time interval is not a sensing eligible frame time interval.

As a side note, it can be seen that in this illustration, the first predetermined value is given by the multiplication of a factor k with the remaining data transmission capacity in the current superframe.

If it is determined that the amount of backlog data (including data scheduled to be transmitted during the current frame time interval) is less than the first predetermined value in step 315, the processing moves to step 319.

In step 319, if it is determined that the average data packet transmission delay measurement is less than the predetermined delay threshold, the processing moves to step 311, where it is determined that the current frame time interval is a sensing eligible frame time interval.

As mentioned earlier, in one embodiment, the predetermined delay threshold is selected to be 50% of the average data packet transmission delay of the corresponding data traffic class for the data packet, when the traffic load is at 90%.

Alternatively, if it is determined that the average data packet transmission delay measurement is not less than the predetermined delay threshold (in step 319), the processing moves to step 317, where it is determined that the current frame time interval is not a sensing eligible frame time interval.

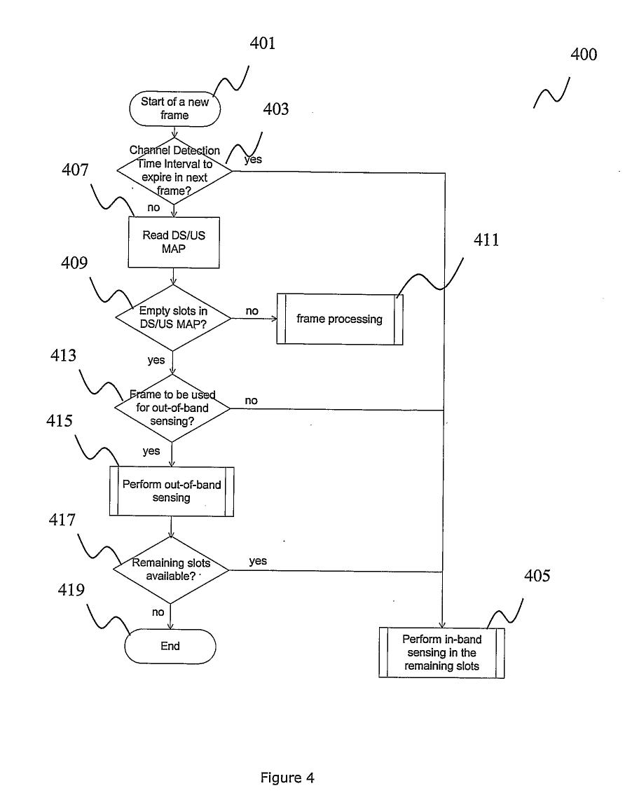

FIG. 4 shows a flow chart 400 describing a third method of determining whether the current frame time interval is selected for performing in-band sensing, according to one embodiment of the invention.

The third method of determining whether the current frame time interval is selected for performing in-band sensing, begins at step 401. In step 403, if it is determined that the channel detection time interval will expire in the next frame time interval, the processing moves to step 405, where the current frame time interval will be used for performing in-band sensing.

As mentioned earlier, a frame may comprise subframes. Further, a subframe may comprise of slots. In other words, a number of adjacent slots are grouped together in order to form a subframe.

Step 405 mentions that in-band sensing is performed in slot time intervals. In this regard, when the processing moves from step 403 to step 405, all slot time intervals are used for performing in-band sensing.

Alternatively, if it is determined that the channel detection time interval will not expire in the next frame time interval in step 403, the processing moves to step 407, where the Up Stream (US)/Down Stream (DS) Map is read.

As mentioned earlier, the first communication device may be a transmitting and/or receiving station, which is usually strategically located. In one embodiment, the first communication device may be a base station.

In this regard, a down stream (DS) transmission, as used herein, refers to a transmission in the direction from a first communication device to a second communication device.

In this context, for example, in a cognitive radio system, the second communication device may be a customer premise equipment (CPE).

In contrast to the down stream transmission, an up stream transmission (US) refers to a transmission in the direction from the second communication device to the first communication device.

In this context, the Up Stream (US)/Down Stream (DS) Map refers to the data transmission schedule for up stream and down stream data transmissions for the current frame time interval. Accordingly, information on whether there is data transmission scheduled for the current frame time interval, for example, may be obtained from the Up Stream (US)/Down Stream (DS) Map.

Next, in step 409, if it is determined that there are no slots in the current frame where no data transmission has been scheduled (for these slots), the processing moves to step 411, where further frame processing is carried out. In this regard, the current frame will not be selected for performing in-band sensing.

If it is determined that there are slots in the current frame where no data transmission has been scheduled in step 409, the processing moves to step 413.

In step 413, if it is determined that the current frame time interval is not scheduled for use in performing out-of-band sensing, the processing moves to step 405, where the slot time intervals in the current frame (in which no data transmission has been scheduled) will be used for performing in-band sensing.

If it is determined that the current frame time interval is scheduled for use in performing out-of-band sensing, the processing moves to step 415, where a predetermined number of slot time intervals in the current frame will be used for performing out-of-band sensing.

Next, in step 417, if it is determined that there are remaining slots in the current frame, the processing proceeds to step 405, where the remaining slot time intervals in the current frame will be used for performing in-band sensing. Alternatively, if it is determined that there are no more slots remaining in the current frame, in step 417, the processing ends, at step 419.

As a side note, for a cognitive radio system, for example, the first method discussed in relation to FIG. 2 or the second method discussed in relation to FIG. 3 may be used for a basestation, while the third method discussed in relation to FIG. 4 may be used for a custumer premise equipment (CPE).

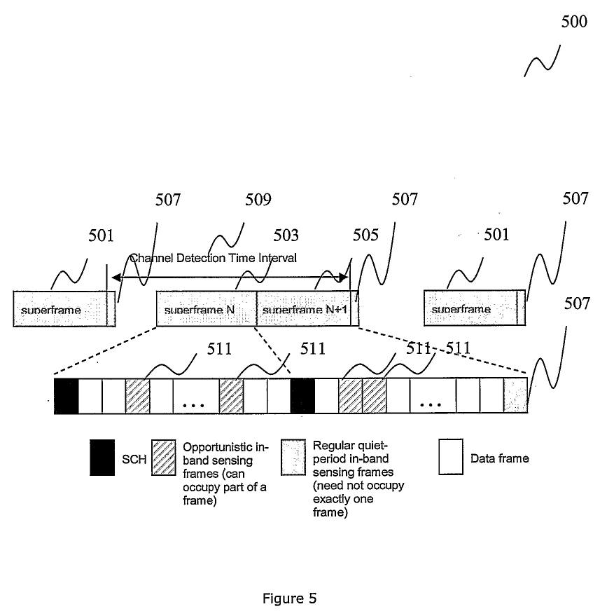

FIG. 5 shows a timing diagram 500, which indicates where common quiet periods for in-band sensing may be dynamically allocated, according to one embodiment of the invention.

The timing diagram 500 shows superframes 501, including superframe N 503 and superframe N+1 505. In this embodiment, common quiet periods 507 are regularly scheduled for in-band sensing at the end of every 2 superframes 501. Since these common quiet periods 507 are regularly scheduled at fixed intervals, these common quiet periods 507 may be considered as static common quiet periods.

In this regard, the time interval between two adjacent static common quiet periods is referred to as the channel detection time interval 509. The channel detection time interval 509 is a system-related parameter, which indicates the time interval during which a common quiet period must be scheduled for in-band sensing at least once.

Additionally, in this embodiment, common quiet periods may also be dynamically allocated, according to a set of predetermined criteria. The dynamic allocation of common quiet periods and the data traffic-based criteria had been discussed earlier in relation to FIGS. 2, 3 and 4.

The dynamically allocated common quiet periods are labeled as 511 in FIG. 5. In this illustration, there are 4 dynamically allocated common quiet periods 511.

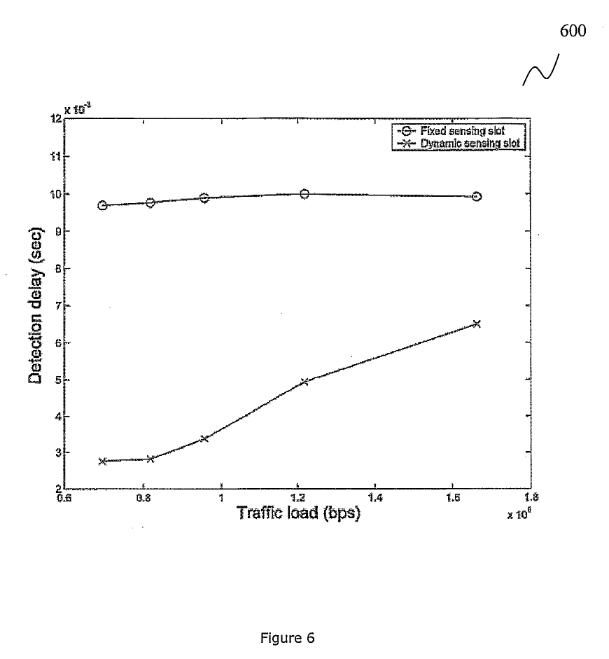

FIG. 6 shows a set of performance results 600 of one embodiment of the invention, with regard to the detection delay parameter.

The performance results shown in FIGS. 6-11 are obtained using the OPNET simulation tool, with the following parameters.
a. A single cell with one basestation and 3 customer premise equipment (CPE).
b. Data traffic is generated using stochastic ON-OFF process.
c. Data traffic load is varied by changing the OFF state duration.
d. Only the down stream link has data traffic.
e. Link capacity is 5 Mbps.
f. The scheduling algorithm is the single-queue FCFS.

The strategy for allocating frames for use in performing in-band sensing, according to one embodiment of the invention, may be described as follows.

In every superframe, at least one frame must be allocated for in-band sensing. This means if a superframe has, say, 20 frames, for example, at least one of the 20 frames must be allocated for use in performing in-band sensing. It also means that if none of the first 19 frames of the superframe is allocated for use in performing in-band sensing, the last frame (or 20^{th} frame) of the superframe must be allocated for use in performing in-band sensing.

Additionally, the allocation of the sensing frame is not fixed but is dynamically changed according to data traffic conditions. If no data transmission is scheduled for the current frame, the current frame is automatically allocated as a sensing frame (the first data traffic based criterion). If the backlog data is less than the remaining data transmission capacity of the current superframe and no sensing frame has been allocated in the current superframe, the current frame is selected as the sensing frame (the second data traffic based criterion). If the current frame is the last frame of the current superframe and no sensing frame has been allocated in the current superframe, the current frame will be selected as the sensing frame.

Two experiments were carried out. The parameters used in the first experiment are as follows.

In the first experiment, each superframe has 10 frames. Each frame time interval is a fixed duration 2 ms.

Additionally, an incumbent signal transmission arrives randomly. The time between two incumbent signal transmission arrivals is exponentially distributed with a mean 100 ms. Also, an incumbent signal transmission stays in the cell for an exponentially distributed duration with a mean 100 ms.

The results obtained for the first experiment are shown in FIGS. 6-8.

In the second experiment, each superframe has 20 frames. Each frame time interval is a fixed duration 10 ms.

Additionally, an incumbent signal transmission arrives randomly. The time between two incumbent signal transmission arrivals is exponentially distributed with a mean 1000 ms. Also, an incumbent signal transmission stays in the cell for an exponentially distributed duration with a mean 1000 ms.

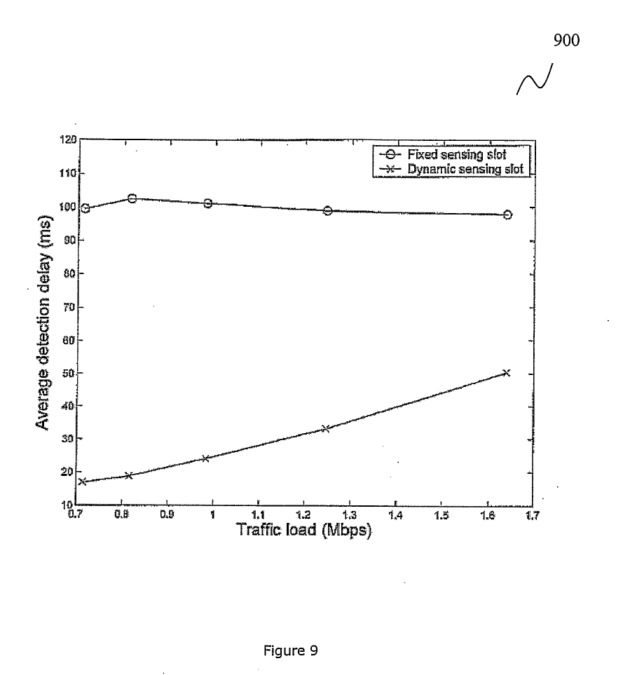

The results obtained for the second experiment are shown in FIGS. 9-11.

Further, in the two experiments carried out, a superframe structure with a fixed sensing slot allocation is used as the benchmark scheme, for comparison purposes.

From the results shown in FIG. 6, it can be seen that the detection delay for the benchmark scheme (indicated by the legend Fixed Sensing Slot) is about 10×10⁻³ s (or 10 ms), regardless of the data traffic load. However, the detection delay for this embodiment of the invention (indicated by the legend Dynamic Sensing Slot) is between about 2.5 ms to about 6.5 ms, depending on the data traffic load. Accordingly, from the results shown in FIG. 6, it can be seen that a reduction in detection delay of about 3.6 times may be achieved using this embodiment of the invention, at low data traffic loads.

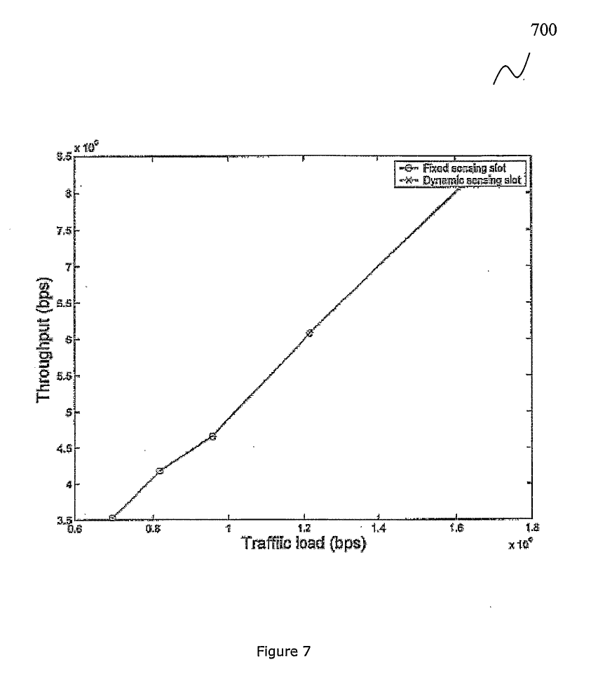

FIG. 7 shows a set of performance results 700 of one embodiment of the invention, with regard to the throughput parameter.

From the results shown in FIG. 7 with regard to the throughput parameter, it can be seen that the throughput achieved for this embodiment of the invention (indicated by the legend Dynamic Sensing Slot) is almost the same as that for the benchmark scheme (indicated by the legend Fixed Sensing Slot), for all data traffic loads. This means that the reduction in detection delay achieved (as shown in FIG. 6) does not result in a lower throughput.

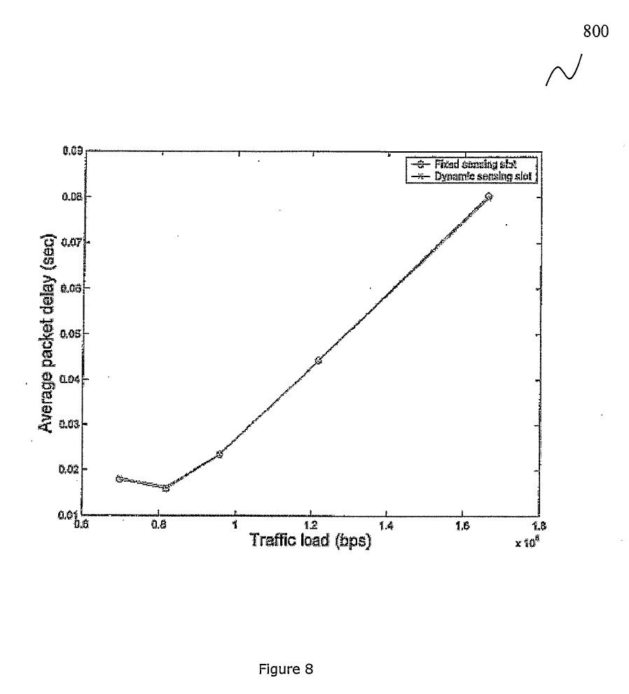

FIG. 8 shows a set of performance results 800 of one embodiment of the invention, with regard to the average data packet delay parameter.

From the results shown in FIG. 8 with regard to the average data packet delay parameter, it can be seen that the average data packet delay for this embodiment of the invention (indicated by the legend Dynamic Sensing Slot) is almost the same that as for the benchmark scheme (indicated by the legend Fixed Sensing Slot), for all data traffic loads. Similar to the discussion in FIG. 7, this means that the reduction in detection delay achieved (as shown in FIG. 6) does not result in a higher average data packet delay.

As a side remark, since the quiet periods uses only the idle frames (or frames on which no data traffic has been scheduled) of the data traffic in the first experiment, the average throughput and average packet delay for the data traffic are not affected (as shown by the results in FIGS. 7 and 8). Additionally, when there are no idle frames in a superframe, a common quiet period (for in-band sensing) is explicitly scheduled into the superframe, resulting in a same performance as that obtained from the benchmark fixed common quiet period scheduling scheme, for all data traffic loads. In other words, at worst, this embodiment of the invention would have the same performance as that of the benchmark scheme.

FIG. 9 shows another set of performance results 900 of one embodiment of the invention, with regard to the detection delay parameter.

From the results shown in FIG. 9, it can be seen that the detection delay for the benchmark scheme (indicated by the legend Fixed Sensing Slot) is about 100 ms, regardless of the data traffic load. However, the detection delay for this embodiment of the invention (indicated by the legend Dynamic Sensing Slot) is between about 15 ms to about 55 ms, depending on the data traffic load. Accordingly, from the results shown in FIG. 9, it can be seen that a significant reduction in detection delay may be achieved using this embodiment of the invention, at low data traffic loads.

As a side remark, it is noted that when compared with the first experiment, the size of the superframe in this second experiment is now longer (by roughly 10 times). As such, the average detection delay for the benchmark fixed common quiet period scheduling scheme in this second experiment is also about 10 times longer than that in the first experiment, for the corresponding data traffic load.

It is also noted that the average detection delay with this embodiment of the invention is also longer than that from the first experiment, since the frame size is now longer. However, the reduction in average detection delay from using this embodiment of the invention instead of the benchmark scheme is now larger (as compared to the first experiment), since the increase in the average detection delay with the use of the benchmark scheme is greater than that with the use of this embodiment of the invention.

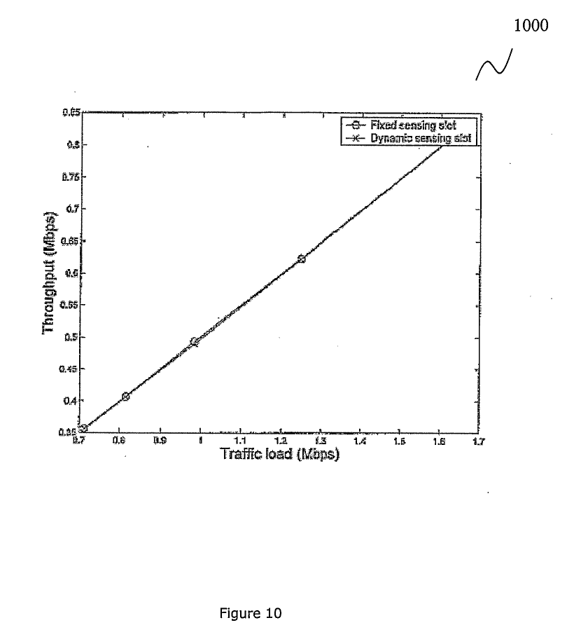

FIG. 10 shows another set of performance results 1000 of one embodiment of the invention, with regard to the throughput parameter.

From the results shown in FIG. 10 with regard to the throughput parameter, it can be seen that the throughput achieved for this embodiment of the invention (indicated by the legend Dynamic Sensing Slot) is almost the same as that for the benchmark scheme (indicated by the legend Fixed Sensing Slot), for all data traffic loads. This means that the reduction in detection delay achieved (as shown in FIG. 9) does not result in a lower throughput.

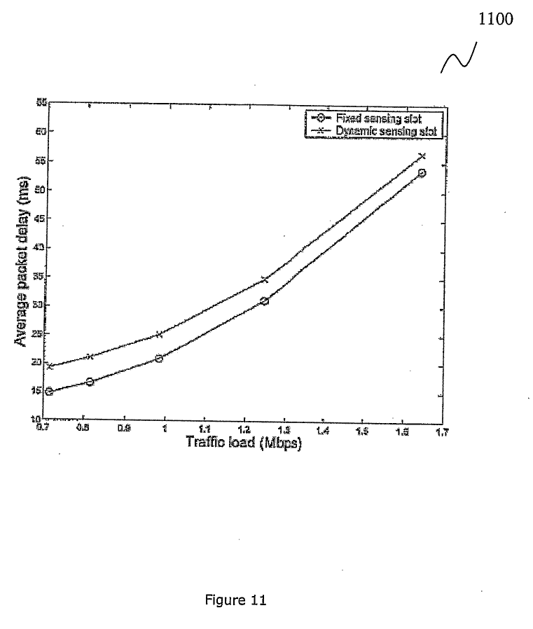

FIG. 11 shows another set of performance results 1100 of one embodiment of the invention, with regard to the average data packet delay parameter.

From the results shown in FIG. 11 with regard to the average data packet delay parameter, it can be seen that the average data packet delay for this embodiment of the invention (indicated by the legend Dynamic Sensing Slot) is about 5 ms more than that for the benchmark scheme (indicated by the legend Fixed Sensing Slot), for all data traffic loads. This means that the reduction in detection delay achieved (as shown in FIG. 9) is obtained at a cost of a higher average data packet delay.

As a side remark, it can be seen from FIG. 11 that the average packet delay is increased. This increase is due to the implementation of this embodiment of the invention. In this implementation, more than one customer premise equipment (CPE) data transmission per frame is allowed, since the frame size is now longer and is thus able to support such an implementation. As a result, more frames used for performing in-band sensing are now selected based on the second data traffic-based criterion (frames with less traffic).

In this case, when a frame is selected for use in performing in-band sensing based on the second data traffic-based criterion, the data traffic (which had been originally scheduled for the said frame) is re-scheduled for transmission in the subsequent frames. Accordingly, the average packet delay increases.

Additionally, it can be seen that while the third data traffic-based criterion (which has been described earlier in relation to FIG. 2) is not directly included in the above mentioned two experiments, nevertheless it may be applied in order to prevent the average packet delay parameter from increasing indefinitely.

Further, it is noted that the above mentioned situation does not appear in the first experiment because the frame size is smaller. As such, there can be only one customer premise equipment (CPE) data transmission in one frame in the first experiment.

Additionally, it can be seen from FIG. 10 that the throughput is not affected by the use of this embodiment of the invention. In this case, the throughput remains unaffected by the above mentioned situation, since the average service rate of the channel remains unchanged from the first experiment to the second experiment.

As a side remark, the embodiments of the invention have been described with reference to specific communication systems, for example. It should be understood by those skilled in the art that these embodiments may be used in wireless communication systems, such as cellular communication systems, for example. Examples of cellular communication systems include the systems according to GSM, FOMA, UMTS and 3GPP, for example.

Embodiments of the invention have the following advantages.

Firstly, it can be seen from FIGS. 6-11 that the average detection delay performance of the embodiments of the invention is better than that of the conventional benchmark scheme. With the reduced average detection delay obtained using the embodiments of the invention, a higher detection accuracy (where the detection accuracy is quantified by the probability of correct detection and the probability of false detection) may be obtained. As a result, better overall system performance may be achieved.

Secondly, it can also be seen that the implementation of the embodiments of the invention does not require any hardware changes and only involves some changes at the software level. Accordingly, the embodiments of the invention are thus easy to implement.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

In this document, the following publication is cited:
[1] IEEE 802.22 Working Group. IEEE P802.22/D0.1 Draft Standard for Wireless Regional Area Networks Part 22: Cognitive Wireless RAN Medium Access Control (MAC) and Physical Layer (PHY) specifications: Policies and procedures for operation in the TV Bands, May 2006.

1. A method of determining whether a frequency channel is available for data transmission for a communication device, comprising:
dynamically selecting a time interval for determining whether the frequency channel is available for data transmission for the communication device, and
determining whether the frequency channel is available for data transmission for the communication device during the time interval selected.

2. The method of claim 1, wherein the time interval is selected in accordance with a predetermined criterion.

3. The method of claim 2, wherein the predetermined criterion is that
no data transmission is scheduled for the time interval.

4. The method of claim 3, further comprising
determining whether the frequency channel is available for
data transmission for the communication device, during the time interval, if it is determined that the time interval is not used for determining whether another frequency channel is available for data transmission for the communication device.

5. The method of claim 2, wherein the predetermined criterion is that
the amount of backlog data, including data scheduled to be transmitted during the time interval, is less than a first predetermined value.

6. The method of claim 5, wherein
the first predetermined value is a measure of the remaining data transmission capacity.

7. The method of claim 6, wherein
the first predetermined value has a value in the range from 0 to 1.

8. The method of claim 1, further comprising
determining whether the frequency channel is available for data transmission for the communication device, during the time interval, if it is determined that a predetermined detection time interval will expire during the time interval immediately following the time interval selected.

9. The method of claim 8, wherein
the length of the predetermined detection time interval is less than 2 seconds.

10. The method of claim 1, wherein the predetermined criterion is that
the percentage of reports received by the communication device or another communication device, indicating that the frequency channel is not available for data transmission for the communication device, is greater than a second predetermined value.

11. (canceled)

12. The method of claim 1, wherein the predetermined criterion is that
the average data packet transmission delay measurement is less than a predetermined delay threshold.

13. The method of claim 1, further comprising
determining whether the frequency channel is available for data transmission for the communication device, during the time interval, if it is determined that the time difference between the time interval and another time interval during which the determining whether the frequency channel is available for data transmission for the communication device was last performed, is greater than the predetermined detection time interval.

14. The method of claim 1, determining whether the frequency channel is available for data transmission for the communication device further comprises
determining whether a signal transmission in the frequency channel is below a predetermined threshold,
in case the signal transmission in the frequency channel is below the predetermined threshold, then classifying the frequency channel as being available for data transmission,
in case the signal transmission in the frequency channel is not below the predetermined threshold, then classifying the frequency channel as being non-available for data transmission.

15. A method of determining whether a frequency channel is available for data transmission for a first communication device and a second communication device, comprising:
dynamically selecting a time interval for determining whether the frequency channel is available for data transmission, wherein the selection of the time interval is performed by the first communication device,
transmitting information regarding the time interval selected from the first communication device to the second communication device, and
determining whether the frequency channel is available for data transmission, during the time interval selected, wherein the determination is performed by the first communication device and the second communication device.

16. The method of claim 15, wherein the time interval is selected in accordance with a predetermined criterion.

17. The method of claim 16, wherein the predetermined criterion is that
no data transmission is scheduled for the time interval.

18. The method of claim 16, wherein the predetermined criterion is that
the amount of backlog data, including data scheduled to be transmitted during the time interval, is less than a predetermined value.

19. The method of claim 16, wherein the predetermined criterion is that
the percentage of reports received by the communication device or another communication device, indicating that the frequency channel is not available for data transmission for the communication device, is greater than a second predetermined value.

20. The method of claim 16, wherein the predetermined criterion is that
the average data packet transmission delay is less than a predetermined delay threshold.

21. A frequency channel determination device for determining whether a frequency channel is available for data transmission for a communication device, comprising
a selection unit programmed to dynamically select a time interval for determining whether the frequency channel is available for data transmission for the communication device, and
a determination unit programmed to determine whether the frequency channel is available for data transmission for the communication device, during the time interval selected.

22. The device of claim 21, wherein the time interval is selected in accordance with a predetermined criterion.

23. The device of claim 22, wherein the predetermined criterion is that
no data transmission is scheduled for the time interval.

24. The device of claim 22, wherein the predetermined criterion is that
the amount of backlog data, including data scheduled to be transmitted during the time interval, is less than a predetermined value.

25. The device of claim 22, wherein the predetermined criterion is that
the percentage of reports received by the communication device or another communication device, indicating that the frequency channel is not available for data transmission for the communication device, is greater than a second predetermined value.

26. The device of claim 22, wherein the predetermined criterion is that
the average data packet transmission delay is less than a predetermined delay threshold.

27. A communication device, comprising a frequency channel determination device for determining whether a frequency channel is available for data transmission for the communication device, the frequency channel determination device comprising
a selection unit, programmed to dynamically
select a time interval for determining whether the frequency channel is available for data transmission for the communication device, and
a determination unit, programmed to determine
whether the frequency channel is available for data transmission for the communication device, during the time interval selected.

28. The communication device of claim 27, wherein the time interval is selected in accordance with a predetermined criterion.

29. The communication device of claim 28, wherein the predetermined criterion is that
no data transmission is scheduled for the time interval.

30. The communication device of claim 28, wherein the predetermined criterion is that
the amount of backlog data, including data scheduled to be transmitted during the time interval, is less than a predetermined value.

31. The communication device of claim 28, wherein the predetermined criterion is that
the percentage of reports received by the communication device or another communication device, indicating that the frequency channel is not available for data transmission for the communication device, is greater than a second predetermined value.

32. The communication device of claim 28, wherein the predetermined criterion is that
the average data packet transmission delay is less than a predetermined delay threshold.

33-40. (canceled)
